(19) United States
(12) Patent Application Publication
(10) Pub. No.: US 2018/0046452 A1
(43) Pub. Date: Feb. 15, 2018

(54) SYSTEMS AND METHODS FOR PROVIDING OVER THE AIR FIRMWARE UPDATES

(71) Applicant: TTI (MACAO COMMERCIAL OFFSHORE) LIMITED, Macau (MO)

(72) Inventors: Michael Preus, Greenville, SC (US); William McNabb, Anderson, SC (US)

(21) Appl. No.: 15/670,340

(22) Filed: Aug. 7, 2017

Related U.S. Application Data
(60) Provisional application No. 62/373,741, filed on Aug. 11, 2016.

(51) Int. Cl. G06F 9/44; G07C 9/00; G06F 11/14

(52) U.S. Cl. CPC G06F 8/68; G06F 11/1433; G07C 9/00309; G06F 8/61

(57) ABSTRACT

A garage door opener includes a wireless transceiver, a memory storing a first firmware image and a second firmware image, and a device electronic processor coupled to the wireless transceiver and the memory. The device electronic processor is configured to receive, via the wireless transceiver, an over-the-air firmware update message including a command to begin an over-the-air firmware update and a location of a firmware update image on a server. The device electronic processor is further configured to receive, via the wireless transceiver, the firmware update image from the server and to determine an inactive firmware image of the first firmware image and the second firmware image. The device electronic processor overwrites, in the memory, the inactive firmware image with the firmware update image, and reboots using the firmware update image from the memory.

### RELATED APPLICATIONS

This application claims benefit of priority to U.S. Provisional Application No. 62/373,741, filed Aug. 11, 2016, titled “Systems and Methods for Providing Over the Air Firmware Updates,” the content of which is hereby incorporated by reference in its entirety and for all purposes.

### TECHNICAL FIELD

Embodiments described herein relate generally to providing firmware updates in garage door openers.

### SUMMARY

Embodiments described herein relate to updating firmware on devices, such as garage door openers, and, more specifically, to enabling over-the-air firmware updates on garage door openers.

In one embodiment, a garage door opener is provided that includes a wireless transceiver, a memory storing a first firmware image and a second firmware image, and an electronic processor coupled to the wireless transceiver and the memory. The electronic processor is configured to receive, via the wireless transceiver, an over-the-air firmware update message including a command to begin an over-the-air firmware update and a location of a firmware update image on a server. The electronic processor is further configured to receive, via the wireless transceiver, the firmware update image from the server and to determine an inactive firmware image of the first firmware image and the second firmware image. The electronic processor overwrites, in the memory, the inactive firmware image with the firmware update image, and reboots using the firmware update image from the memory.

In another embodiment, a method is provided for updating firmware of a garage door opener over-the-air. The method includes receiving, via a wireless transceiver of the garage door opener, an over-the-air firmware update message including a command to begin an over-the-air firmware update and a location of a firmware update image on a server. The method also includes receiving, via the wireless transceiver, the firmware update image from the server. In the method, the electronic processor of the garage door opener determines an inactive firmware image of a first firmware image and a second firmware image stored on a memory of the garage door opener. The method further includes overwriting, in the memory of the garage door opener, the inactive firmware image with the firmware update image, and rebooting, by the electronic processor, using the firmware update image from the memory.

In another embodiment, a garage door opener equipped for updating a firmware of the garage door opener is provided. The garage door opener includes a motor configured to move a movable door; a wireless transceiver; a memory storing a first firmware image and a second firmware image; and an electronic processor. The electronic processor is coupled to the wireless transceiver and the memory, and is configured to receive, via the wireless transceiver, an over-the-air firmware update message. The over-the-air firmware update message includes a command to begin an over-the-air firmware update and a location of a firmware update image on a server. The electronic processor is configured to receive, via the wireless transceiver, the firmware update image from the server, and to determine an inactive firmware image of the first firmware image and the second firmware image. The electronic processor is further configured to overwrite, in the memory, the inactive firmware image with the firmware update image, and reboot using the firmware update image from the memory.

In another embodiment, a system for updating a firmware of a motorized device is provided. The system includes a firmware update server and a motorized device. The firmware update server includes a network communication interface; a server memory storing a firmware update image; and a server electronic processor coupled to the network communication interface and the server memory. The server electronic processor is configured to transmit, via the communication interface, the firmware update image from the server. The motorized device includes a motor; a wireless transceiver; a memory storing a first firmware image and a second firmware image; and a device electronic processor. The device electronic processor is coupled to the wireless transceiver and the memory. Additionally, the device electronic processor is configured to receive, via the wireless transceiver, the firmware update image, responsive to a command to begin an over-the-air firmware update. The device electronic processor is further configured to determine an inactive firmware image of the first firmware image and the second firmware image, and to overwrite, in the memory, the inactive firmware image with the firmware update image. The device electronic processor is further configured to reboot using the firmware update image from the memory.

Other features and aspects of the invention will become apparent by consideration of the following detailed description and accompanying drawings.

### BRIEF DESCRIPTION OF THE DRAWINGS

FIG. 1 is a view of a garage door opener system.

FIG. 2 is a view of a garage door opener of the garage door system in FIG. 1.

FIGS. 3A-B illustrate a block power diagram of the garage door opener of FIG. 2.

FIG. 4 is a block communication diagram of the garage door opener of FIG. 2.

FIG. 5 is a diagram of a firmware update system for the garage door opener of FIG. 2.

FIG. 6 is flowchart for providing over-the-air firmware updates.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

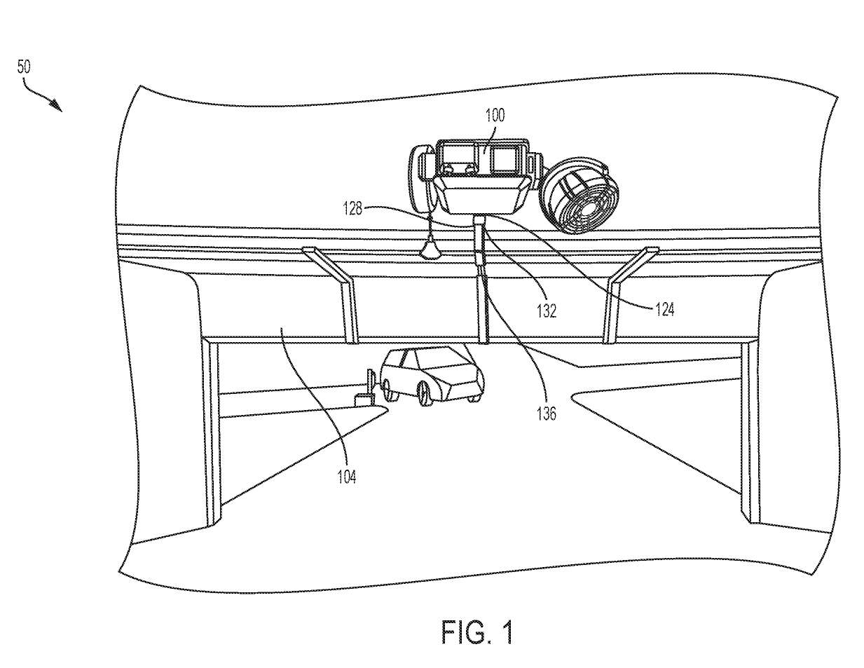

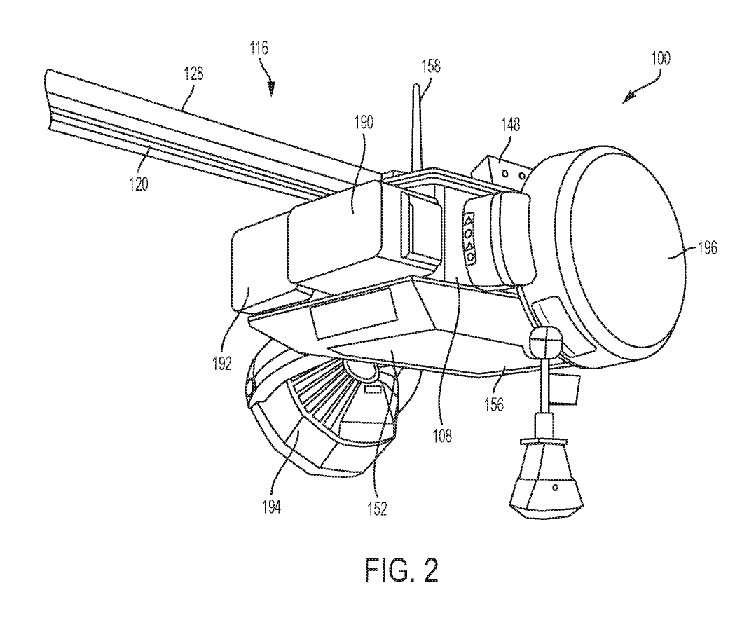

FIGS. 1-2 illustrate a garage door system 50 including a garage door opener 100 operatively coupled to a garage door 104. The garage door opener 100 includes a housing 108 supporting a motor that is operatively coupled to a drive mechanism 116. The drive mechanism 116 includes a transmission coupling the motor to a drive chain 120 having a shuttle 124 configured to be displaced along a rail assembly 128 upon actuation of the motor. The shuttle 124 may be selectively coupled to a trolley 132 that is slidable along the rail assembly 128 and coupled to the garage door 104 via an arm member.

The trolley 132 is releaseably coupled to the shuttle 124 such that the garage door system 50 is operable in a powered mode and a manual mode. In the powered mode, the trolley 132 is coupled to the shuttle 124 and the motor is selectively driven in response to actuation by a user (e.g., via a key pad or wireless remote in communication with the garage door opener 100). As the motor is driven, the drive chain 120 is driven by the motor along the rail assembly 128 to displace the shuttle 124 (and, therefore, the trolley 132), thereby opening or closing the garage door 104. In the manual mode, the trolley 132 is decoupled from the shuttle 124 such that a user may manually operate the garage door 104 to open or close without resistance from the motor. The trolley 132 may be decoupled, for example, when a user applies a force to a release cord 136 to disengage the trolley 132 from the shuttle 124. In some embodiments, other drive systems are included such that, for example, the drive mechanism 116 includes a transmission coupling the motor to a drive belt that is operatively coupled to the garage door 104 via a rail and carriage assembly.

The housing 108 is coupled to the rail assembly 128 and a surface above the garage door (e.g., a garage ceiling or support beam) by, for example, a support bracket 148. The garage door opener further includes a light unit 152 including a light (e.g., one or more light emitting diodes (LEDs)) enclosed by a transparent cover or lens 156), which provides light to the garage. The light unit 152 may either be selectively actuated by a user or automatically powered upon actuation of the garage door opener 100. In one example, the light unit 152 may be configured to remain powered for a predetermined amount of time after actuation of the garage door opener 100.

The garage door opener 100 further includes an antenna 158 enabling the garage door opener 100 to communicate wirelessly with other devices, such as a smart phone or network device (e.g., a router, hub, or modem), as described in further detail below. The garage door opener 100 is also configured to receive, control, and/or monitor a variety of accessory devices, such as a backup battery unit 190, a speaker 192, a fan 194, an extension cord reel 196, among others.

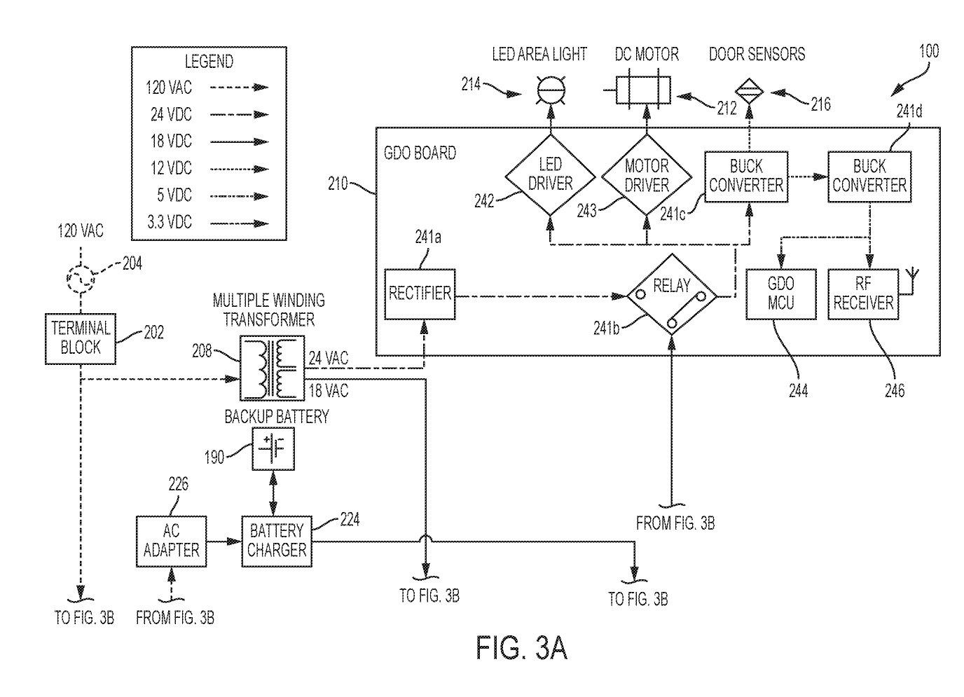

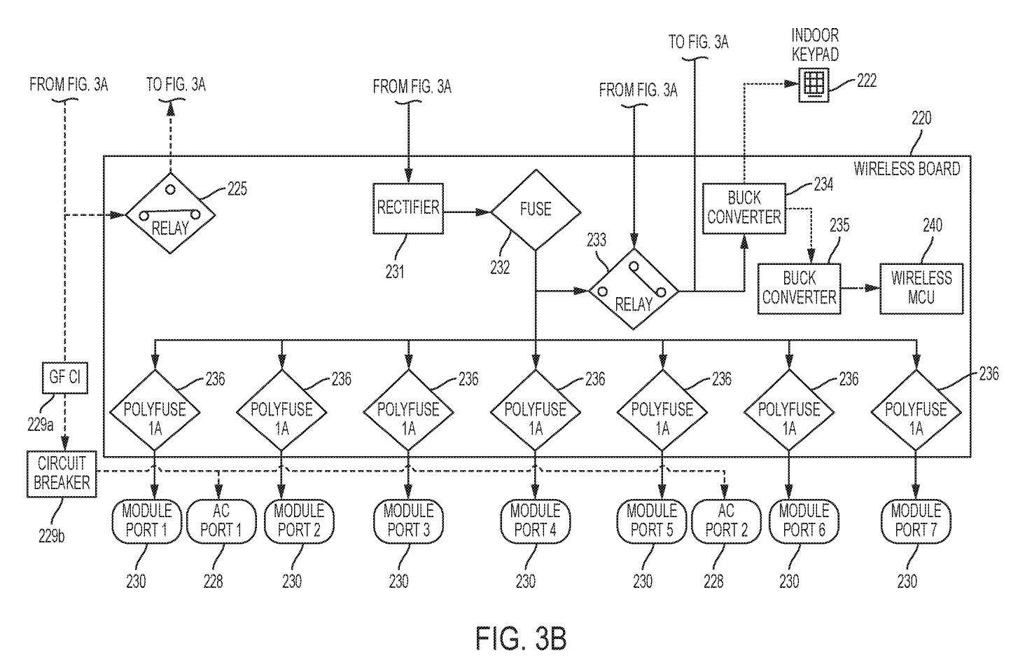

FIGS. 3A-B illustrate a block power diagram of the garage door opener 100. The garage door opener 100 includes a terminal block 202 configured to receive power from an external power source 204, such as a standard 120 VAC power outlet. The terminal block 202 directs power, via a transformer 208, to a garage door opener (GDO) board 210 for supply to components thereof as well as a motor 212 (used to drive the drive mechanism 116, as described above), LEDs 214 (of the light unit 152), and garage door sensors 216. The terminal block 202 further directs power via the transformer 208 to a wireless board 220 and components thereof, as well as a wired keypad 222 and module ports 230. The terminal block 202 also directs power to a battery charger 224 (via a relay 225 and an AC adapter 226) and AC ports 228 (via a ground fault circuit interrupter (GFCI) 229a and a circuit breaker 229b). The module ports 230 are configured to receive various accessory devices, such as a speaker, a fan, an extension cord reel, a parking assist laser, an environmental sensor, a flashlight, and a security camera. One or more of the accessory devices are selectively attachable to and removable from the garage door opener 100, and may be monitored and controlled by the garage door opener 100.

The wireless board 220 has power conditioning components for receiving and providing power from the transformer 208 including a rectifier 231, fuse 232, relay 233, buck converter 235, buck converter 236, and polyfuses 237 (also referred to as a polymeric positive temperature coefficient (PPTC) device) that acts as a resettable fuse for overcurrent protection. The wireless board 220 also includes a wireless microcontroller 240, among other components. In the illustrated embodiment, the wireless microcontroller 240 receives power via the rectifier 231, fuse 232, relay 2333, buck converter 235 and buck converter 236.

The GDO board 210 has power conditioning components for receiving and providing power from the transformer 208 including a rectifier 241a, relay 241b, buck converter 241c, and buck converter 241d. The GDO board 210 also includes an LED driver 242 for driving the LEDs 214 and a motor driver 243 for driving the motor 212. The GDO board 210 includes, among other components, a garage door opener (GDO) microcontroller 244 and a radio frequency (RF) receiver 246.

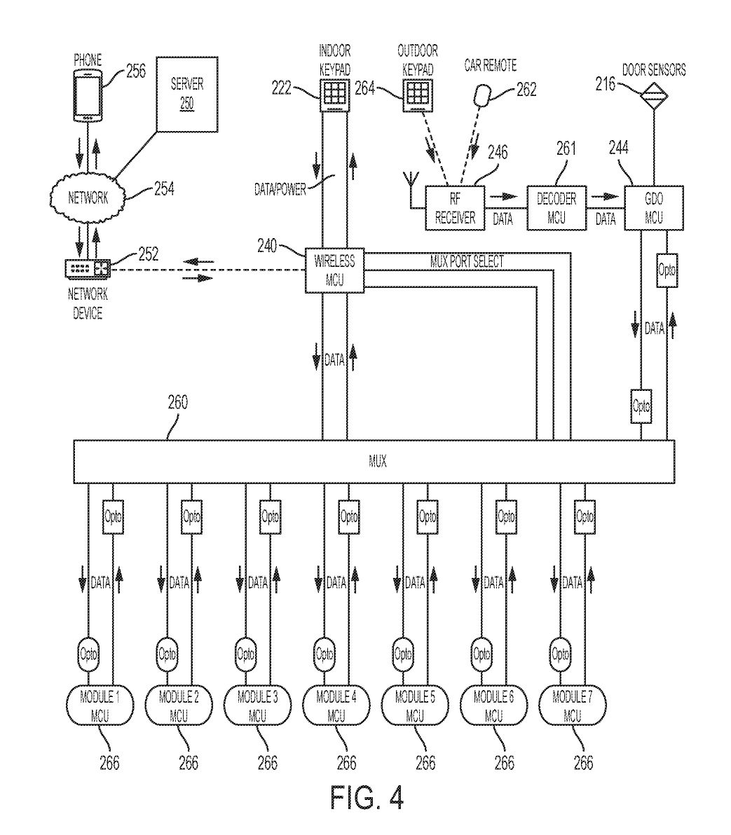

FIG. 4 illustrates a block communication diagram of the garage door opener 100. The wireless microcontroller 240 is coupled to the antenna 158 and enables wireless communication with a server 250 via a network device 252 and network 254, as well as with a smart phone 256 (and other similar external devices, such as tablets and laptops). The network device 252 may be, for example, one or more of a router, hub, or modem. The network 254 may be, for example, the Internet, a local area network (LAN), another wide area network (WAN) or a combination thereof. The wireless microcontroller 240 may include, for example, a Wi-Fi radio including hardware, software, or a combination thereof enabling wireless communications according to the Wi-Fi protocol. In other embodiments, the wireless microcontroller 240 is configured to communicate with the server 250 via the network device 252 and network 254 using other wireless communication protocols. The network 254 may include various wired and wireless connections to communicatively couple the garage door opener 100 to the server 250. As illustrated, the wireless microcontroller 240 also includes wired communication capabilities for communicating with the GDO microcontroller 244 via the multiplexor 260. In some embodiments, the wireless microcontroller 240 and the GDO microcontroller 244 are directly coupled for communication. In some embodiments, the wireless microcontroller 240 and the GDO microcontroller 244 are combined into a single controller.

The GDO microcontroller 244 is coupled to the RF receiver 246 for communication via a decoder microcontroller 261. The RF receiver 246 is wirelessly coupled to various user actuation devices, including one or more wireless remotes 262 and wireless keypads 264, to receive and provide to the GDO microcontroller 244 user actuation commands (e.g., to open and close the garage door 104). The smart phone 256 may also receive user input and, in response, provide (directly or via the network 254) to the wireless microcontroller 240 user actuation commands for the garage door opener 100 or commands to control one or more of the accessory devices. The multiplexor 260 enables communication between and among the wireless microcontroller 240, the GDO microcontroller 244, and the accessory microcontrollers 266 (of the accessory devices previously noted).

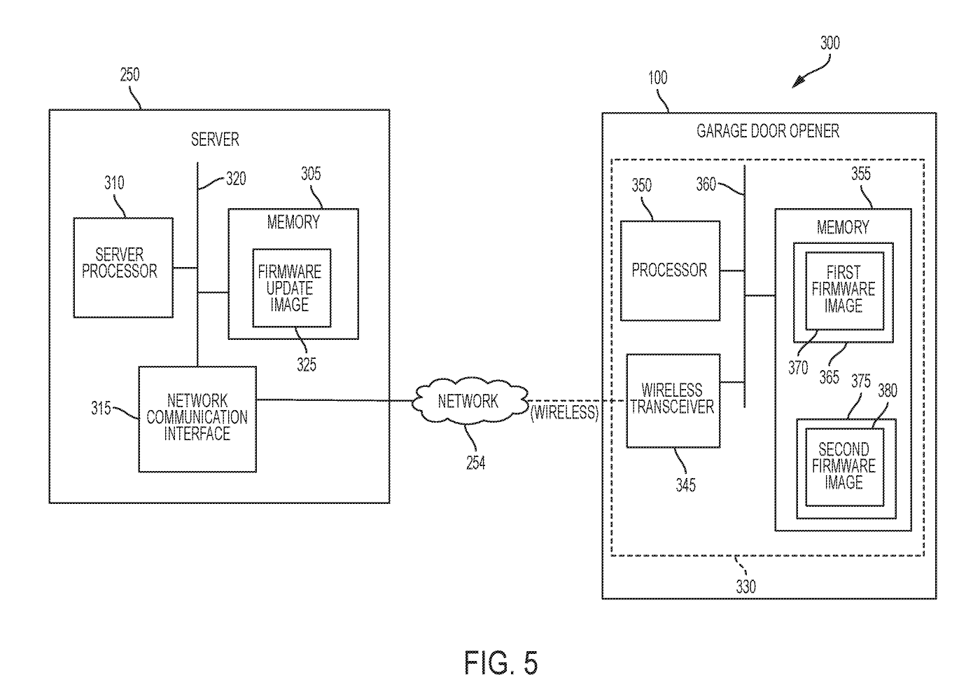

FIG. 5 illustrates a diagram of a firmware update system 300. The firmware update system 300 includes the garage door opener 100, server 250, and network 254. For ease of illustration and description, the network device 252 is considered part of the network 254 in FIG. 5 and not separately illustrated. The server 250 includes a server memory 305, a server processor (e.g., an electronic server processor) 310, and a network communication interface 315 coupled by a communication bus 320. Stored on the server memory 305 is a firmware update image 325. The firmware update image 325 may be received from another device (e.g., another computer coupled to the network 254) and is a firmware update to be used to update the firmware residing on the garage door opener 100, as describe in further detail below.

The garage door opener 100 includes a wireless controller 330. Only select components of the wireless controller 330 are illustrated, including a wireless transceiver 345, a processor (e.g., an electronic processor) 350, and a memory 355. The wireless transceiver 345 may be part of the wireless microcontroller 240 (FIG. 4). The processor 350 and memory 355 may be part of the GDO microcontroller 244 (FIG. 4). The processor 350, memory 355, and wireless transceiver 345 are in communication via a communication bus 360, which may include the multiplexor 260 (FIG. 4). The memory 355 includes a first nonvolatile memory block 365 storing a first firmware image 370 and a second nonvolatile memory block 375 storing a second firmware image 380.

As initially configured (e.g., upon shipping from the manufacturer), the first firmware image 370 and the second firmware image 380 are duplicates such that one may be a backup for the other in the case of an error or data corruption. The first and second firmware images 370 and 380 include the low-level control program for the garage door opener 100. For example, upon startup of the garage door opener 100, the processor 350 retrieves and executes the code in the first firmware image 370 to carry out the functionality of the garage door opener 100. If an error is encountered during execution of the first firmware image 370, the processor 350 may switch to retrieve and execute the code in the second firmware image 380. The switch may occur as a result of the processor 350 detecting an error upon reading from the memory 355 or a stall condition, or may occur in response to a hard reset of the garage door opener 100. For example, the processor 350 may be configured to alternate between firmware images 370 and 380 in response to a power reset (e.g., power at the terminal block 202 is disconnected from and then reconnected to the garage door opener 100).

In some instances, it is desirable to update the firmware on the garage door opener 100. For example, the firmware may be updated to correct an error in the firmware detected after manufacture, to overwrite firmware that may have been corrupted after manufacture, to provide new functionality for the garage door opener 100 (e.g., upon availability of a new accessory device), to adjust existing functionality of the garage door opener 100, among other reasons.

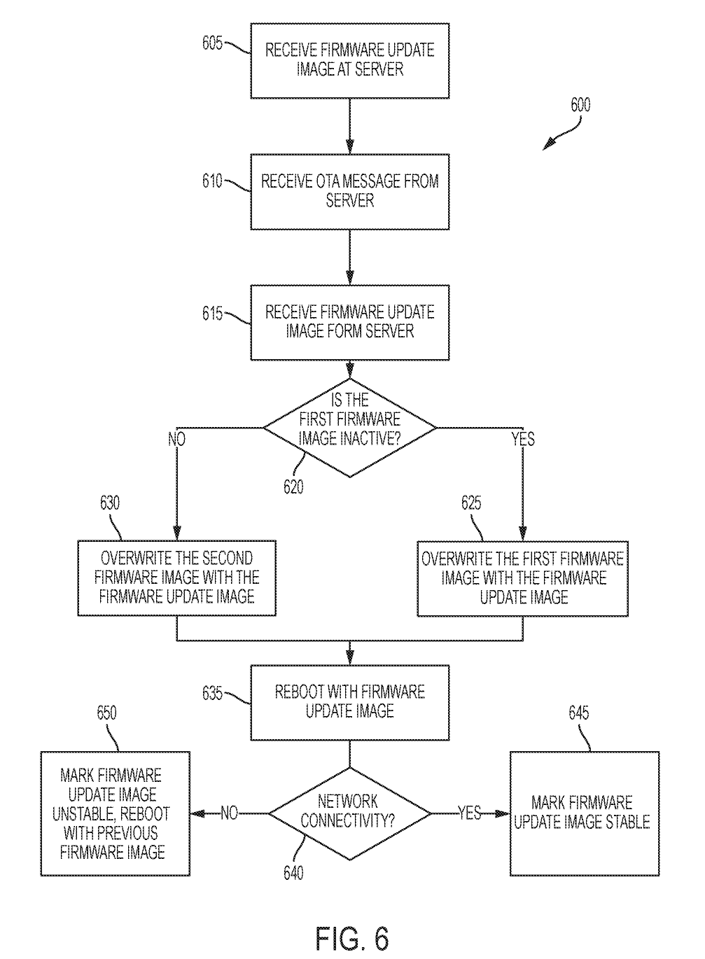

FIG. 6 illustrates a method 600 of providing over-the-air firmware updates. In step 605, the server 250 receives the firmware update image 325. For example, the server 250 may receive the firmware update image 325 from another computer (not shown) in communication with the server 250 over the network 254. The computer may be, for example, that of the manufacturer of the garage door opener 100. The server processor 310 stores the received firmware update image 325 in the server memory 305. The firmware update image 325 may replace a previous firmware image stored in the server memory 305, or may be stored along with previous firmware image(s) in the memory.

In step 610, the processor 350 of the garage door opener 100 receives an over-the-air (OTA) update message from the server 250 via the network 254. For example, the server processor 310 sends the OTA update message in response to receiving and storing the firmware update image 325, in response to a command from another computer (e.g., of the manufacturer) to initiate an OTA firmware update of the garage door opener 100, or as part of a regularly timed maintenance. The OTA update message includes a command to start an OTA firmware update and a location (e.g., a memory address) of the firmware update image 325 on the server 250. In some embodiments, another device coupled to the network 254 or otherwise wirelessly connected to the wireless transceiver 345 wirelessly provides the OTA update message to the garage door opener 100.

In step 615, the processor 350 of the garage door opener 100 receives the firmware update image 325 over-the-air from the server 250 via the network 254. For example, in response to the command received in step 610, the processor 350 sends a read request to the server 250 including the location of the firmware update image 325. In response, the server 250 sends the firmware update image 325 to the processor 350 of the garage door opener 100. As the garage door opener 100 is in wireless communication with the network 254 (via the wireless transceiver 345), the firmware update image 325 is received over-the-air, even though the communications between the network 254 and the server 250 may include wired communications. The firmware update image 325 may be a complete or partial firmware image.

In step 620, the processor 350 determines which firmware image of the memory 355 is inactive. For example, at start-up of the garage door opener 100 (e.g., upon application of power at the terminal block 202), the processor 350 retrieves the most recent, stable firmware image available on the memory 355 for booting. As an example, the memory 355 may store a firmware selection indicator (e.g., at a particular address) indicating which firmware image is the most recent and stable firmware image. Accordingly, on start-up, the processor 350 may check the firmware selection, determine that first firmware image 370 is the most recently stored firmware image that is considered stable, and then begin executing the first firmware image 370. In this start-up example, the first firmware image 370 is considered an active firmware image, and the second firmware image 380 is considered inactive. Returning to step 620, the processor 350 determines whether the first firmware image 370 is inactive (and the second firmware image 380 is active) or the second firmware image 380 is inactive (and the first firmware image 370 is active). For example, the processor 350 may check the firmware selection indicator in step 620 to determine the inactive firmware image. In one example, the firmware selection indicator may be an address pointer to the memory block 365 or the memory block 375, whichever is the most recent, stable firmware image.

The processor 350 proceeds to overwrite the inactive firmware image in the memory 355. For example, in step 625, if the first firmware image 370 is inactive, the processor 350 overwrites the first firmware image 370 with the firmware update image 325 received from the server 250. In other words, the processor 350 stores the firmware update image 325 to the first nonvolatile memory block 365 of the memory 355. If, however, the second firmware image 380 is inactive, in step 630, the processor 350 overwrites the second firmware image 380. In other words, the processor 350 stores the firmware update image 325 to the second nonvolatile memory block 375 of the memory 355. After the firmware update image 325 is stored in the memory 355, the processor 350 considers the firmware update image 325 to be the most recent firmware image that is stable (for instance, by updating the firmware selection value in the memory 355).

Because the inactive firmware image is overwritten, the processor 350 may continue to execute the active firmware image and may continue to function during the course of the over-the-air firmware update. Thus, the garage door opener 100 may receive user actuations (e.g., via one of the keypads 222,264) and, in response, control the garage door 104 to open or close, in parallel with receiving and storing the firmware update image 325. In other words, the garage door opener 100 may receive and store an over-the-air firmware update without going off-line.

In step 635, the processor 350 reboots and retrieves the firmware update image 325 from the memory 355 for execution, as it is the most recent, stable firmware image. The processor 350 then attempts to connect to the server 250 via the network 254 and wireless transceiver 345. For example, the processor 350 sends a test message to the server 250 and awaits a reply to determine whether a connection is established. If connectivity is established with the server 250 (e.g., the processor 350 receives a reply within a certain amount of time) the processor 350 continues operating with the firmware update image 325. For example, the processor 350 executing the firmware update image 325 may, based on receipt of a user actuation and execution of the firmware update image 325, drive the motor 212 to open or close the garage door 104. In some embodiments, the processor 350 proceeds to step 645 to mark (e.g., via a write to the memory 355) that the firmware update image 325 is the most recent, stable firmware image.

If connectivity is not established with the server 250 (e.g., the processor 350 does not receive a reply within a certain amount of time) the processor 350 proceeds to step 650 to mark the firmware update image 325 as unstable, and reboots using the previous firmware image (e.g., the initially active firmware image found to be active in step 620). As the firmware update image 325 is considered unstable, the processor 350 would consider the previous firmware image to be the most recent, stable firmware image. An error in the firmware update that renders the firmware update image 325 unstable could occur for various reasons, including: a connection failure between the processor 350 and the server 250 during a transfer of the firmware update image 325 (e.g., in step 615), a power outage while storing the firmware update image 325 (e.g., in step 625 or 630), or an error in the code of the firmware update image 325. The processor 350 executing the previous firmware image may, based on receipt of a user actuation and execution of the previous firmware image, drive the motor 212 to open or close the garage door 104.

Although the method 600 is described as a series of ordered steps, in some embodiments, one or more of the steps of the method 600 are carried out in a different order, in parallel, or both. Additionally, in some embodiments, one or more steps of the method 600 are not included, such as one or more of steps 605, 610, 640, 645, and 650. Although the method 600 is described with respect to the garage door opener 100, in some embodiments, the method 600 is also applicable to other wirelessly connected appliances.

Accordingly, embodiments disclosed herein enable providing firmware updates over-the-air to a garage door opener. This enables updating of firmware on existing, installed garage door openers (e.g., installed in a user's garage) to correct corrupted firmware, to correct firmware errors, to provide additional functionality, or to adjust existing functionality. Further, embodiments disclosed herein provide a back-up firmware image to enable firmware updates without taking the garage door opener off-line (i.e., out of service) and to enable a backup in the event an error occurs in the other firmware image or newly updated firmware image. Some embodiments disclosed herein include other advantages not expressly listed as well.

The processors described herein may be configured to carry out the functionality attributed thereto via execution of instructions stored on a computer readable medium (e.g. one of the illustrated memories), in hardware circuits (e.g., an application specific integrated circuit (ASIC) or field programmable gate array) configured to perform the functions, or a combination thereof.

Although the invention has been described in detail with reference to certain preferred embodiments, variations and modifications exist within the scope and spirit of one or more independent aspects of the invention as described.

What is claimed is:

1. A garage door opener equipped for updating a firmware of the garage door opener, the garage door opener comprising:
a motor configured to move a movable door;
a wireless transceiver;
a memory storing a first firmware image and a second firmware image; and
an electronic processor coupled to the wireless transceiver and the memory, wherein the electronic processor is configured to
receive, via the wireless transceiver, an over-the-air firmware update message including a command to begin an over-the-air firmware update and a location of a firmware update image on a server,
receive, via the wireless transceiver, the firmware update image from the server,
determine an inactive firmware image of the first firmware image and the second firmware image,
overwrite, in the memory, the inactive firmware image with the firmware update image, and
reboot using the firmware update image from the memory.

2. The garage door opener of claim 1, wherein the second firmware image is the inactive firmware image that is overwritten and the first firmware image is an initially active firmware image, and wherein the electronic processor is further configured to:
attempt to verify that the firmware update image is stable, and
responsive to a failure to verify that the firmware update image is stable, mark the firmware update image as unstable and reboot using the initially active firmware image.

3. The garage door opener of claim 1, wherein the second firmware image is the inactive firmware image that is overwritten and the first firmware image is an initially active firmware image, and wherein the electronic processor is further configured to:
attempt to connect to the server via a network and the wireless transceiver by sending a test message to the server, and
responsive to a failure to receive a reply from the server within a certain amount of time, mark the firmware update image as unstable and reboot using the initially active firmware image.

4. The garage door opener of claim 1, wherein the electronic processor is further configured to:
attempt to connect to the server via a network and the wireless transceiver by sending a test message to the server, and
responsive to a reply from the server, mark the firmware update image as stable and continue operating using the firmware update image.

5. The garage door opener of claim 1, wherein the second firmware image is the inactive firmware image that is overwritten and the first firmware image is an initially active firmware image, and wherein the electronic processor is further configured to:
continue to execute one or more functions of the garage door opener by continuing to execute the initially active firmware image during at least one selected from a group of
receiving the firmware update image from the server, and
overwriting the inactive firmware image with the firmware update image.

6. The garage door opener of claim 1, wherein the electronic processor is further configured to:
transmit to the server, via the wireless transceiver, a read request for the firmware update image with the location of the firmware update image on the server.

7. The garage door opener of claim 1, further comprising:
a housing that supports the motor, the wireless transceiver, the memory, and the electronic processor;
a radio frequency receiver coupled to the electronic processor and configured to receive wireless commands;
the electronic processor is further configured to:
drive the motor in response to a door command received by the radio frequency receiver, during at least one selected from a group of
receiving the firmware update image from the server, and
overwriting the inactive firmware image with the firmware update image.

8. A method for updating firmware of a garage door opener via a wireless data connection, the method comprising:
driving a motor of the garage door opener to move a garage door;
receiving, via a wireless transceiver of the garage door opener, an over-the-air firmware update message including a command to begin an over-the-air firmware update;
receiving, via the wireless transceiver, a firmware update image from a server;
determining, by an electronic processor of the garage door opener, an inactive firmware image of a first firmware image and a second firmware image stored on a memory of the garage door opener;
overwriting, in the memory of the garage door opener, the inactive firmware image with the firmware update image; and
rebooting, by the electronic processor, using the firmware update image from the memory.

9. The method of claim 8, wherein the second firmware image is the inactive firmware image that is overwritten and the first firmware image is an initially active firmware image, and the method further comprising:
attempting to verify that the firmware update image is stable, and
responsive to a failure to verify that the firmware update image is stable, marking the firmware update image as unstable and rebooting using the initially active firmware image.

10. The method of claim 8, wherein the second firmware image is the inactive firmware image that is overwritten and the first firmware image is an initially active firmware image, and the method further comprising:
attempting to connect to the server via a network and the wireless transceiver by sending a test message to the server, and
responsive to a failure to receive a reply from the server within a certain amount of time, mark the firmware update image as unstable and rebooting using the initially active firmware image.

11. The method of claim 8, further comprising:
attempting to connect to the server via a network and the wireless transceiver by sending a test message to the server, and
responsive to a reply from the server, marking the firmware update image as stable and continuing to operate using the firmware update image.

12. The method of claim 8, further comprising:
wirelessly receiving, by a radio frequency receiver of the garage door opener, a door command;
operating the motor in response to the door command during at least one selected from a group of
receiving the firmware update image from the server, and
overwriting the inactive firmware image with the firmware update image.

13. The method of claim 8, further comprising:
transmitting to the server, via the wireless transceiver, a read request for the firmware update image and a location of the firmware update image on the server,
wherein the over-the-air firmware update message received from the server included the location of the firmware update image on the server.

14. The method of claim 8, wherein the second firmware image is the inactive firmware image that is overwritten and the first firmware image is an initially active firmware image, the method further comprising:
continuing to execute the initially active firmware image during the over-the-air firmware update.

15. A system for updating firmware, the system comprising:
a firmware update server, comprising:
a network communication interface;
a server memory storing a firmware update image; and
a server electronic processor coupled to the network communication interface and the server memory, wherein the server electronic processor is configured to transmit, via the network communication interface, the firmware update image from the firmware update server; and
a motorized device comprising:
a motor;
a wireless transceiver;
a memory storing a first firmware image and a second firmware image; and
a device electronic processor coupled to the wireless transceiver and the memory, wherein the device electronic processor is configured to
responsive to a command to begin an over-the-air firmware update, receive, via the wireless transceiver, the firmware update image,
determine an inactive firmware image of the first firmware image and the second firmware image,
overwrite, in the memory, the inactive firmware image with the firmware update image, and
reboot using the firmware update image from the memory.

16. The system of claim 15, wherein the second firmware image is the inactive firmware image that is overwritten and the first firmware image is an initially active firmware image, and wherein the device electronic processor is further configured to:
attempt to verify that the firmware update image is stable, and
responsive to a failure to verify that the firmware update image is stable, mark the firmware update image as unstable and reboot using the initially active firmware image.

17. The system of claim 15, wherein the server electronic processor is further configured to:
receive a test message from the motorized device via the network communication interface, and
reply to the test message.

18. The system of claim 17, wherein the device electronic processor is further configured to:
attempt to connect to the firmware update server via a network and the wireless transceiver by sending the test message to the firmware update server, and
responsive to the reply from the firmware update server, mark the firmware update image as stable and continue operating using the firmware update image.

19. The system of claim 15, wherein the second firmware image is the inactive firmware image that is overwritten and the first firmware image is an initially active firmware image, and wherein the device electronic processor is further configured to:
continue to execute one or more functions of the motorized device by continuing to execute the initially active firmware image during the over-the-air firmware update.

20. The system of claim 15, wherein the device electronic processor is further configured to:
transmit to the firmware update server, via the wireless transceiver, an over-the-air firmware update message including a read request for a firmware update and a location of the firmware update image on the firmware update server.
